(19) United States
(12) Patent Application Publication
(10) Pub. No.: US 2004/0022326 A1
(43) Pub. Date: Feb. 5, 2004

(54) Digital audio receiver

(76) Inventors: John Morrish, Glasgow (GB); Jean-Marc Villevieille, Phoenix, AZ (US)

Correspondence Address: John Morrish, Global Radio, S.A., 33 Parc d'Activite Syrdall, L-5363 Munsbach, Luxembourg, BE

(21) Appl. No.: 10/207,048

(22) Filed: Jul. 30, 2002

(51) Int. Cl. H04L 27/06

(52) U.S. Cl. 375/316; 375/329

(57) ABSTRACT

A digital audio broadcast receiver for a satellite audio broadcasting system may include two RF tuner systems and a single base band decoding chip. The two RF tuner systems may be configured to filter and down-convert signal from at least one antenna. The satellite tuner may down-convert a single carrier high level of modulation signal maximizing the data capacity compared to equivalent S-DARS systems. The single base band decoding chip configured to process at least two channel decoding functions to combine streams from each of the two RF tuner system and extract useful information for presenting to a user interface. The single base band decoding chip is based on a software driven DSP architecture topology that allows software upgrades and services and protocols evolution delaying the receiver hardware obsolescence.

### FIELD OF THE INVENTION

The invention is generally related to audio receivers. More particularly, the invention is related to digital audio receivers for a satellite-based mobile digital audio broadcast system.

### BACKGROUND OF THE INVENTION

Satellite digital audio broadcast (DAB) systems are a relatively new area of audio broadcast technology. Satellite DAB systems allow audio stations to broadcast to listeners thousands of miles away through the use of satellites, terrestrial repeaters and DAB audio receivers.

As providers of satellite audio service enter the field, different approaches to audio receiver architecture have been undertaken. One approach (by XM and SIRIUS in the United States), is the use of proprietary protocol stacks, satellite spatial diversity and Lucent's PERCEPTIVE AUDIO CODING (PAC) or Coding Technologies CtaacPlus audio compression standard. Another approach (by WorldSpace and its Afristar satellite), also uses a separate custom protocol that is not compatible with Eureka terrestrial DAB receivers.

### SUMMARY OF THE INVENTION

An audio receiver for a satellite audio broadcasting system may include two radio frequency (“RF”) tuner systems and a single base band decoding chip. The two RF tuner systems may be configured to filter and down-convert signal from at least one antenna from both terrestrial and satellite signals. The single base band decoding chip configured to process at least two channel decoding functions to combine streams from each of the two RF tuner system and extract useful information for presenting to a user interface.

### BRIEF DESCRIPTION OF THE DRAWINGS

The invention is illustrated by way of example and not limitation in the accompanying figures in which like numeral references refer to like elements, and wherein:

FIG. 1 is an exemplary block diagram illustrating one embodiment of a digital audio broadcast system;

FIG. 2 is an exemplary block diagram illustrating one embodiment of a digital audio receiver;

FIG. 3 is an exemplary block diagram illustrating one embodiment of the decoder depicted in FIG. 2;

FIG. 4 is an exemplary block diagram illustrating one embodiment of a structure of a transmission frame of data transmitted in the digital audio broadcast system of FIG. 1; and

FIG. 5 is an exemplary block diagram illustrating one embodiment of a digital audio receiving subsystem.

### DETAILED DESCRIPTION OF THE INVENTION

A digital audio receiver architecture is described. The digital audio receiver may include a “software-driven” dual mode digital audio receiver. In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to obscure unnecessarily the invention.

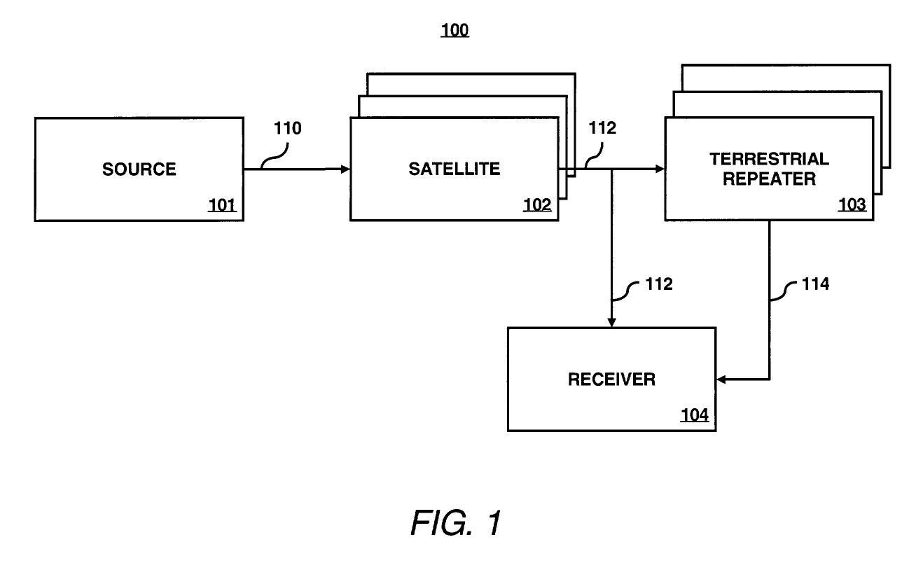

FIG. 1 is an exemplary block diagram illustrating one embodiment of a digital audio broadcast (“DAB”) system 100. The DAB system 100 includes signal source 101, satellite or satellite constellation 102, terrestrial repeater 103 and digital audio receiver 104.

In one embodiment, source 101 broadcasts a signal 110 to satellite(s) 102. Satellite(s) 102 may convert the received signal 110 to RF signal 112 at L-band. The L-band allocated spectrum for Digital audio broadcast for satellites and terrestrial systems is between 1452 to 1492 Mhz. L-band signal 112 may be received by terrestrial repeater 103 and/or receiver 104. Terrestrial repeater 103 may transform L-band signal 112 to a compliant terrestrial DAB signal 114 by changing the modulation but using the same bandwidth between 1452 to 1492 Mhz

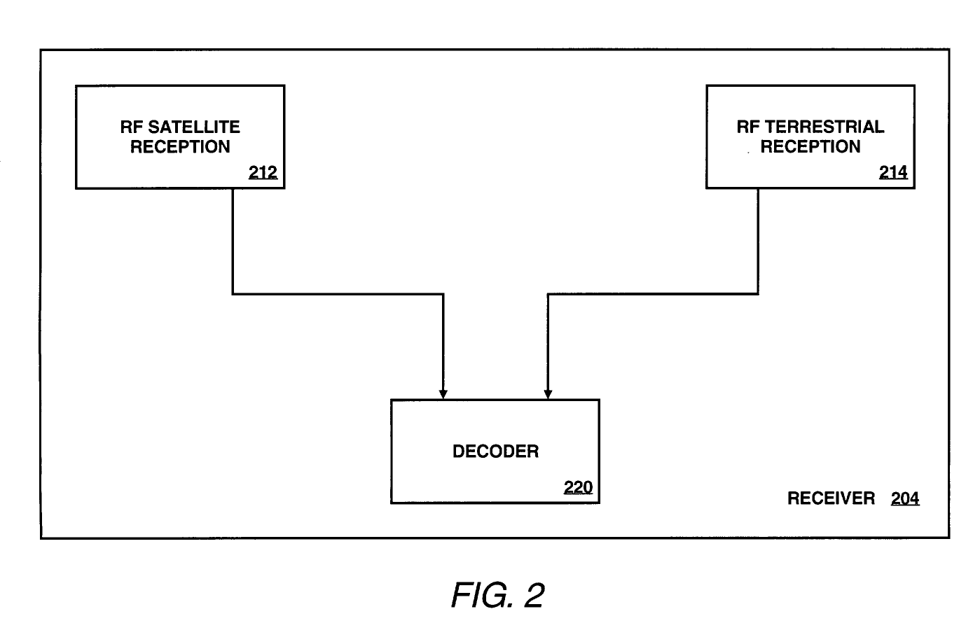

FIG. 2 is a block diagram illustrating an embodiment of the receiver 104 of FIG. 1. The receiver 204 may include a “software-driven” dual mode digital audio receiver. In one embodiment, receiver 204 may include RF satellite reception module 212 for receiving satellite signal 112 and RF terrestrial reception module 214 for receiving terrestrial repeater signal 114.

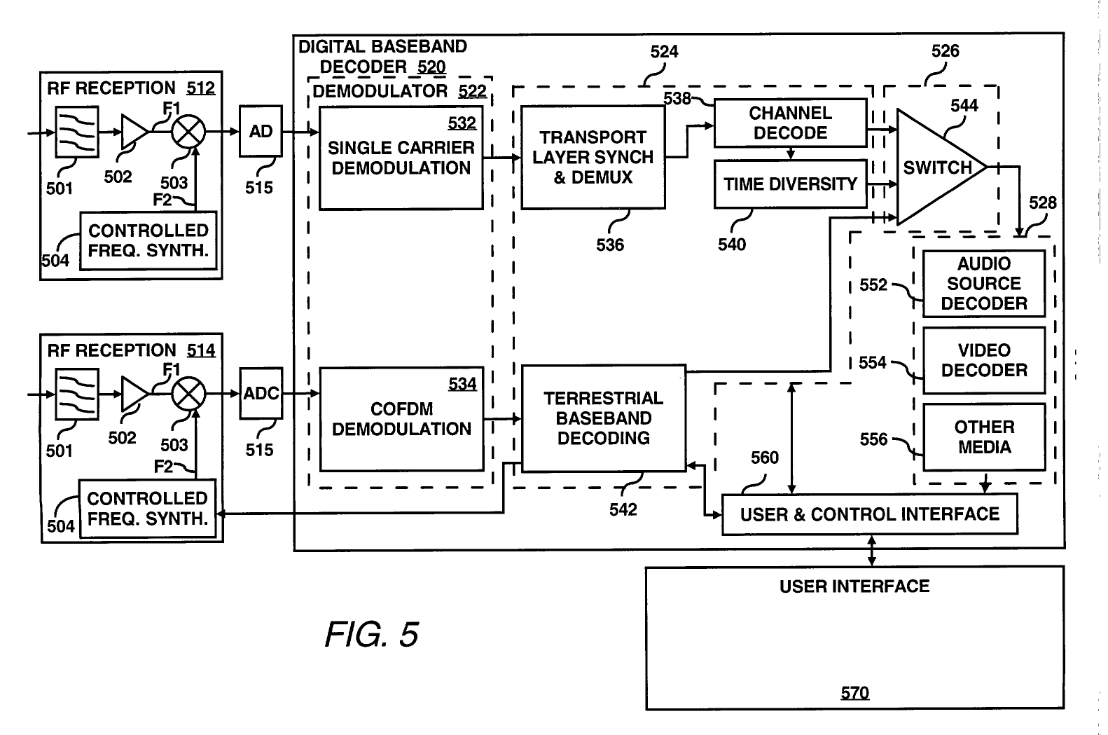

RF reception modules 212, 214 may include two RF tuner systems configured to filter and down-convert signal from at least one antenna (not shown). The at least one antenna may include two antennae or a combination antenna sharing a low noise amplifier at L-band. The two RF tuner systems, described below with reference to FIG. 5, may be configured to filter and down-convert signal so that the signal may be digitally converted by a high sampling rate pair of A/D converters along the whole digital audio broadcast L-Band allocated spectrum.

Receiver 204 may also include decoder 220 including a single baseband decoding chip configured to process at least two channel decoding functions in parallel. The single baseband decoding chip may be based on a standard, off-the-shelf digital signal processor (“DSP”) with performance power of at least 150 MIPS. For example, the DSP may include such commercial platforms as Intel XSCALE, Hitachi SH-4, or Texas Instrument TMS320C5000 or DRE200 series.

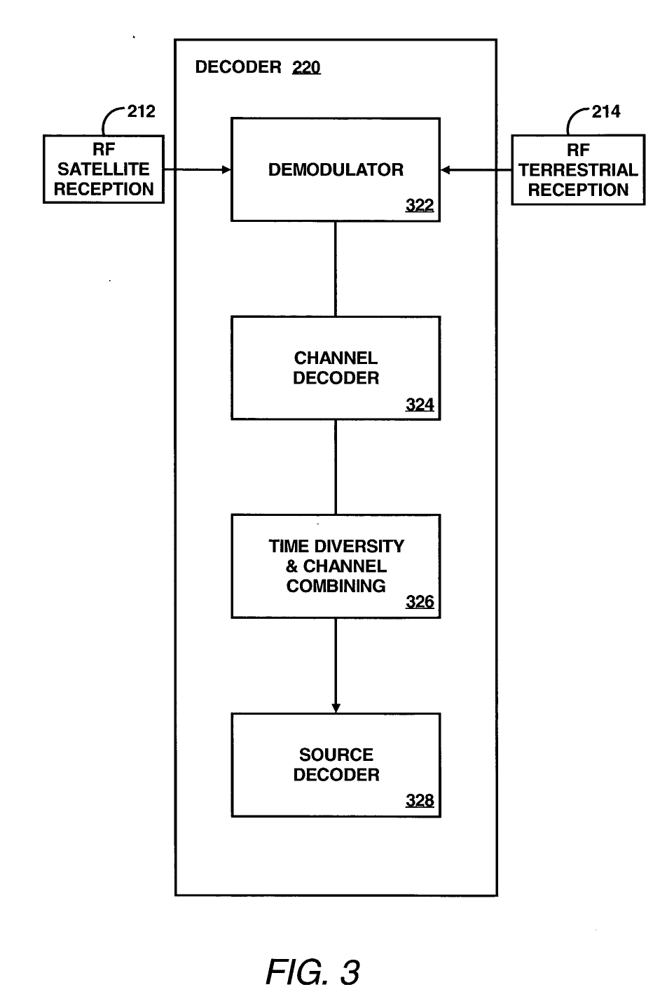

Decoder 220 may be configured to decode and combine streams from each of the tuner systems of RF reception modules 212, 214, and select useful information from the decoded streams to present to a user interface. The at least two channel decoding functions may include one decoding function for satellite signal 112 and one decoding function for terrestrial signal 114. Decoder 220 may also include additional error correction and specific audio and multimedia decoders, described below with reference to FIGS. 3 and 5.

In one embodiment, the combination of RF reception modules 212, 214, providing a direct conversion/zero intermediate frequency RF front-end topology and a “software driven” decoder 220 may allow development of a multi-mode multi-frequency receiver compatible with other satellite digital audio receiver system (S-DARS) manufacturers. Other S-DARS manufacturers may include, for example, US XM and SIRIUS or Japan MBSAT. This would allow worldwide original equipment manufacturers to design one single customizable platform for each continent while preserving a common Service and Application external controller compatible at the digital bus interface “560” level.

FIG. 3 is an exemplary block diagram illustrating one embodiment of decoder 220 of FIG. 2. Decoder 320 may include demodulator 322, channel decoder 324, combining and selection decision module 326 and source decoder 328.

Demodulator 322 may demodulate signals received through RF reception modules 212, 214. Demodulator 322 may include dual demodulation chains, one for a single carrier n-PSK satellite air interface and the other for a Coded Orthogonal Frequency Division Multiplexing (“COFDM”) terrestrial interface. Although the physical and data link layers may differ, the signals digitally share the same transport and upper layers communications protocol stack. This block encompasses the traditional demodulation through digital processing techniques (FFT), the digital equalization for each type of modulation and the synchronization timing commands to the RF front-end down conversion.

Channel decoder 324 may decode the demodulated signals output from demodulator 322. Channel decoder 324 may include a modification of the Eureka-147 physical and data link layer to accommodate power efficient space modulation (n-PSK or QAM) combined with the decoding of a terrestrial multi-frequency signal. This block encompasses the frame stream synchronization, the extraction of the Fast Information Channel stream (FIC) that describes the frames multiplex structure and content, and the Main Service Channel stream (MSC) that hosts all the content. A complete channel decoding algorithm, depending on the type of error detection/correction encoding and the type of stream (terrestrial or satellite), may be applied to each stream (e.g. turbocodes, concatenated Reed-Solomon block code with punctured convolutional Vitterbi code). The selected channel is “de-multiplexed” and “de-interleaved” from the MSC stream. The same is done with the time-shifted “early signal” for time diversity which is stored for later combining. Depending on the power processing of the DSP and available memory buffer, the selected channel or the entire “time-shifted” channel within a “MUX stream” may be stored for time-diversity purpose.

Combining module 326 may be a channel combining and selection decision module for combining streams from each of RF reception modules 212, 214. Three to four possible time-stamped synchronous frames, including “live” from satellite, time-shifted from satellite, and “live” and time-shifted from off-channel terrestrial repeater, may be combined at combining module 326. Satellite channel content may interleave “live” data and “time-shifted” data to provide for time diversity in the event of a temporary hard blockage of satellite line-of-sight signal, for example, in urban canyons or under bridges.

The combining or selection decision may depend on RF field strength criteria, and may vary with noise environment conditions. In one embodiment, the combining decision may be based on best available signal in terms of error rates (bit error rates or Blocks/frame error rates). In another embodiment, the combining may be performed before error correction to maximize chances of achieving the best signal, i.e. using a maximum rate combining technique.

Source decoder 328 may decode the combined signal for presentation to a user. The source decoder will depend on the content: e.g. if the content is audio, it could be a narrow band efficient codec such as CT-aacPlus or PAC or a vocoder; if narrow band video and still frames are used, MPEG-4 or Windows Media (WMA) decoder would be implemented. If content is data, it could be Java, XML, ASCII or executable code.

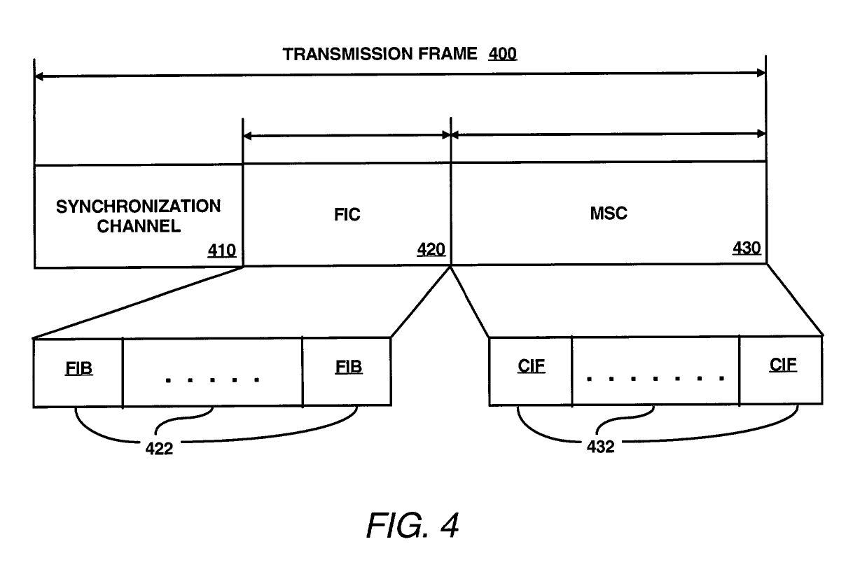

FIG. 4 is an exemplary block diagram illustrating one embodiment of a transmission frame 400 of an exemplary signal that may be transmitted through the DAB system 100. The transmission frame 400 may include synchronization channel 410, fast information channel (“FIC”) 420 and main services channel (“MSC”) 430. FIC 420 may be the “control channel” of transmission frame 400, while MSC includes the payload data.

FIC 420 may include fast information blocks (“FIBs”) 422. The primary function of FIC 420 is to carry control information that is necessary to interpret the configuration of MSC 422. This information may include Multiplex Configuration Information (“MCI”), which includes management information on the multiplex structure and “on the fly” reconfiguration (bit rates, error coding, type of content), service information such as labels for channel name in various languages, Conditional Access information for specially encoded channels such as pay-per-listen or group exclusive content, and Fast Information Data Channel, which includes data common to all main services like an electronic program schedule, traffic information, emergency warning systems, and index of multimedia and program associated data (e.g., name of song and artist, company labels).

In one embodiment, MSC 430 may include up to 16 time-interleaved Common Interleaved Frames (“CIFs”) 432. Each CIF 432 may include a data field of 55,296 bits, transmitted every 24 ms. The smallest addressable unit of CIF 432 is a Capacity Unit (“CU”), having a size of 64 bits. An integral number of CUs may be grouped together to constitute the basic transport unit or sub-channel of MSC 430. MSC 430 is divided into a multiplex of sub-channels, the number depending on the type of content of each channel and audio resolution (mono, stereo, multi-channel 5:1) which is usually a multiple of 8 kbits. Sharing the same multiplex Eureka-147 DAB multiplex structure may allow some data applications to be shared (or extended) by both traditional terrestrial DAB broadcaster and satellite broadcaster, maximizing potential interaction between local services (terrestrial T-DAB) and regional/European-wide satellite services (e.g., traffic, weather reports).

Two different transport modes may be defined for service components in MSC 430, the stream mode and the packet mode. The stream mode may provide a transparent data transmission from source to destination at a fixed bit rate in a given sub-channel. The fixed bit rate may include bit rates that are multiples of 8 kbits/s. The packet mode may be defined for the purpose of conveying several data service components into a single sub-channel. Each sub-channel may carry one or more service components allowing transmission of very small addressable packets down to 24 bytes in size. Alternatively, a data service may be carried in more than one sub-channel. For example, multiple 8 kbps data services may be grouped together in a 32 k or 128 k channel.

FIG. 5 is an exemplary block diagram illustrating one embodiment of a digital audio receiving subsystem. The digital audio receiving subsystem may include two RF reception modules 512, 514 and decoder 520.

Each RF reception module 512, 514 may be coupled to decoder 520 through respective analog to digital converters 515. Each RF reception module 512, 514 may include a signal receiver 501, a low noise amplifier (“LNA”) 502, a controlled frequency synthesizer (“LFS”) 504 and a mixer 503. Signal receiver 501 may receive signal 112, 114 from either satellite 102 or terrestrial 103 sources. The receiver front-end may be similar to any digital RF down-conversion, and known techniques may be applicable whether using a direct conversion/ zero IF (intermediate frequency) schematic, avoiding costly IF spurious frequency rejection filters, or a more traditional 2-stage down conversion with two mixers and two voltage control oscillators (VCO) stages.

FIG. 5 simplifies the detailed block diagram for clarity purposes. The received signal may be input into LNA 502. In one embodiment, a satellite LNA 502 of module 512 may have tighter noise figure performances than the larger dynamic terrestrial LNA 502 of module 514. The RF signal F1 output of LNA 502 and the output F2 of LFS 504 may be input into mixer 503. The output of mixer 503 is filtered, and only the lower frequency product F1-F2 may be down-converted again following the same principle and fed into ADC 515. The signal is digitally sampled through each ADC 515 and further processed through the digital “baseband” decoder 520.

In one embodiment, digital baseband decoder 520 may include demodulator 522, channel decoder 524, combining module 526 and source decoder 528. Demodulator 522 may include satellite demodulation module 532 and terrestrial demodulation module 534 along with digital equalization techniques mandated by the type of modulation. Although reference is made to the Eureka-147 protocol stack, the architecture described is flexible enough to substitute the Eureka-147 protocol stack with a Digital Video Broadcasting stack based on MPEG2 frames promoted by DVB-T (terrestrial) or any other similar protocol stack used for terrestrial multimedia applications.

Decoder 520 may include at least two channel decoding functions. The at least two channel decoding functions may include at least one of baseband decoding for satellite signal 112 and baseband decoding for terrestrial signal 114.

Decoder 520 may be configured to demodulate a Single Carrier Offset Quadrature Phase Shift Keying (“OQPSK”) signal or higher modulation (n-PSK or 16-QAM) received from the satellite(s) 102 in Single Carrier demodulation module 532. The base band decoder for the satellite signal 112 may then demultiplex MSC and FIC data streams in “Transport Layer Synchronizer and Demultiplexer” 536. The demultiplexed signals may be decoded in Channel Decode module 538, where FEC decoding algorithm may be applied.

FEC decoding may include concatenated convolutional code such as Reed Solomon on top of a punctured convolutional Vitterbi bit coding or advanced turbocoding techniques. The resulting decoded frame may be divided into two instances of the same data stream, one being the “late signal” and the other one being a time-shifted “early signal” (an image of the late signal “broadcast” multiple predefined seconds in advance). This “early signal” is stored into the Time Diversity Buffer module 540 for later use in case of signal obstruction of the “Late” signal. In another embodiment, the undecoded “early data stream” may be stored directly in the buffer before channel FEC decoding in order to apply Maximum Rate combining techniques on the raw data stream between the “late” and “early” signal. The Maximum Rate combining techniques may be applied on the raw data stream to maximize signal quality and error concealment.

The baseband decoding channel for the terrestrial signal 114 may be configured to demodulate a Eureka compliant COFDM signal (or alternatively DVB-T compliant COFDM signal) in terrestrial baseband decoding module 542. Terrestrial baseband decoding module 542 may be configured to process COFDM signals in the upper allocated L-Band encoded with the same signals as for the satellite channel (1467-1492 Mhz) or standard DAB signals in the lower L-band portion (1452-1467 Mhz), allowing user access to free terrestrial broadcast services or satellite fee based services.

As described before, the satellite baseband decoding channel may combine time shifted information stored in “Time Diversity Buffer” 540 with “live” broadcast programs through combination module 526. The satellite channel may thus compensate for temporary loss of signal or combine the two signals to get the best quality of service.

Signals from channel decode module 538, time diversity buffer module 540 may be also compared with terrestrial baseband decoding module 542 in combining module 526. The recovered stream from baseband decoding module 542 may be compared to both the satellites early and late frames. Preference may then be given to the best quality signal with an adjustable hysteresis so that signal does not jump from frame to frame to another source of signal. In one embodiment, a switch 544 may be used to achieve the best quality/bit error rate signal. In another embodiment, determining the signal to present to the user may include a maximum rate combiner of the three streams of information (early satellite, late satellite, and current terrestrial). In another embodiment, the terrestrial signal may also contain an “early terrestrial” signal that can also be stored in the Time diversity buffer 540 allowing the switch 544 to operate a 4 to 1 selection.

Audio decoding may be applied in audio source decoder module 552. Audio decoding may include Spectral Bandwidth Replication (“SBR”), which is an enhancement of MPEG2/Adpative Audio Coding (“AAC”) (i.e. CtaacPlus=AAC+SBR) or Perceptual Audio Coding (i.e. PAC) narrow band audio codecs. Video decoding may be applied in video decoder module 554. Video decoding may include MPEG4 or Microsoft WMA video and still frames decoding. Decoding for other media like XML web page scripts, Java applets or program associated data such as artist information may be applied in Other Media module 556.

The decoded data from source decoder module 528 and terrestrial baseband decoding module 542 may be controlled by the user through an external user interface (“UI”) 570. UI 570 connects with the decoder through User & Control Interface (“UCI”) module 560. The UCI module 560 is a bi-directional digital data bus that selects channels or data services from the satellite baseband decoding 524 or terrestrial baseband decoding module 542, and outputs the data stream from the source decoding 528 to UI 570. UI 570 may include any user interface including upper layer services, such as, a car audio sound system, a Driver Entertainment Center or TELEMATICS control unit which may provide all user interfaces, processing and presentation of the selected service. User interface 570 may allow the user to select preferred channels, enter custom information, apply more digital signal treatment to link various digital channels with other car sensors or deal with data services interactivity and display.

Thus, the baseband decoding function described with reference to FIGS. 2-5 are segregated from the upper layer services of UI 570. This topology allows for overall cost reduction and convergence of data services. In one embodiment, the satellite decoder may present a broadband stream of data and multimedia services that may be interpreted by a data gateway linking to other functions (e.g., GPS, wireless phones, wireless LAN, car diagnostics, etc.).

Using Eureka DAB as a “transport data container” protocol allows receiver 204 to be compatible with any class and type of data packets applications, such as the latest versions of narrow band audio and video compression, while maintaining backwards compatibility with terrestrial DAB services. In a transport data container the frames structures, headers, synchronization and control words are left the same but the content are not restricted to the rigid structure of MPEG1-layer 2 or Media Object Transfer (MOT) protocol.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A receiver comprising:
at least two RF tuner systems including a first RF tuner system and a second RF tuner system receiving signals from at least one antenna, the first RF tuner system being configured to filter and down-convert a satellite signal and the second RF tuner system being configured to filter and down-convert a terrestrial digital audio signal; and
a single base band decoding chip configured to process at least two channel decoding functions to decode and combine streams from each of the two RF tuner systems and to select information for presenting to a user interface, wherein the single base band decoding chip allows backward compatibility between the satellite signal and the terrestrial digital audio signal.

2. The receiver of claim 1, wherein the at least one antenna comprises at least one of two antennae and a combination antenna.

3. The receiver of claim 1, wherein the first of the two RF tuner systems demodulates a single carrier satellite signal different from terrestrial COFDM modulation and the second of the two RF tuner systems demodulates a multi carrier signal from a terrestrial source.

4. The receiver of claim 1, wherein the at least two channel decoding functions comprise at least one of a base band decoder for the satellite signal and a base band decoder for the terrestrial signal.

5. The receiver of claim 4, wherein the base band decoder for satellite signal is configured to demodulate a single carrier OQPSK or higher level of modulation (n-PSK, 16-QAM) signal, demultiplex main services channels (MSC) and fast information channels (FEC), apply forward error correction (FEC) channel decoding to the demultiplexed signal and apply either narrow band audio decoding or MPEG-4 low resolution multimedia objects decoding to the FEC -free decoded stream.

6. The receiver of claim 5, wherein the base band decoder for satellite signal is further configured to compensate for temporary loss of signal by hosting program duplication through time-shifted information interleaved with a live broadcast program.

7. The receiver of claim 6, wherein the base band decoder compensates for temporary loss of signal by comparing a stored time buffered early frame of satellite signal to a late frame of satellite signal.

8. The receiver of claim 1, wherein the base band decoder is configured to be segregated from upper layer applications and services.

9. The receiver of claim 1, wherein the base band decoder comprises a software driven baseband decoder and allows continuous updates of software and upper layer services and applications.

10. A method of providing satellite originated broadband data to a mobile user comprising:
receiving a satellite originated data as a satellite signal and a terrestrial repeater signal;
processing at least two channel decoding functions on the satellite signal and the terrestrial repeater signal to decode and combine the satellite signal and the terrestrial repeater signal; and
selecting information from the processed signals for presenting to a user interface.

11. The method of claim 10, further comprising receiving each of the satellite signal and the terrestrial repeater signal through respective RF tuner systems.

12. The method of claim 11, further comprising filtering and down-converting the satellite signal and the terrestrial repeater signal in the respective RF tuner systems with a satellite low noise amplifier (LNA).

13. The method of claim 10, wherein processing the at least two channel decoding functions comprises:
demodulating each of the satellite signal and the terrestrial repeater signal;
performing independent baseband decoding on each of the demodulated satellite signal and the demodulated terrestrial repeater signal, using at least two types of error correction decoding adapted to each channel characteristics; and
combining the decoded satellite signal and the decoded terrestrial repeater signal to produce a combined signal.

14. The method of claim 13, wherein processing the at least two channel decoding functions further comprises source decoding the combined signal.

15. The method of claim 14, wherein source decoding the combined signal comprises at least one of audio decoding, video decoding and media decoding.

16. The method of claim 13, wherein performing baseband decoding on the demodulated satellite signal comprises demultiplexing a main services channel and a fast information channel to provide a demultiplexed signal and performing at least one of channel decoding and time diversity decoding on the demultiplexed signal.

17. The method of claim 13, wherein selecting information from the processed signals comprises selecting one of the combined signal and the baseband decoded terrestrial signal to present to the user interface.

18. A system providing satellite originated data to a user comprising:
means for receiving a satellite originated data as a satellite signal and a terrestrial repeater signal;
means for processing at least two channel decoding functions on the satellite signal and the terrestrial repeater signal to decode and combine the satellite signal and the terrestrial repeater signal; and
means for selecting information from the processed signals for presenting to a user interface.

19. The system of claim 18, further comprising means for receiving each of the satellite signal and the terrestrial repeater signal through respective RF tuner systems.

20. The system of claim 19, further comprising means for filtering and means for down-converting the satellite signal and the terrestrial repeater signal in the respective RF tuner systems.

21. The system of claim 18, wherein the means for processing the at least two channel decoding functions comprises:
means for demodulating each of the satellite signal and the terrestrial repeater signal;
means for performing baseband decoding on each of the demodulated satellite signal and the demodulated terrestrial repeater signal; and
means for combining the decoded satellite signal and the decoded terrestrial repeater signal to produce a combined signal.

22. The system of claim 21, wherein the means for processing the at least two channel decoding functions further comprises means for source decoding the combined signal.

23. The system of claim 22, wherein the means for source decoding the combined signal comprises at least one of means for audio decoding, means for video decoding and means for media decoding.

24. The system of claim 21, wherein the means for performing baseband decoding on the demodulated satellite signal comprises means for demultiplexing a main services channel and a fast information channel to provide a demultiplexed signal and means for performing at least one of channel decoding and time diversity decoding on the demultiplexed signal.

25. The system of claim 21, wherein the means for selecting information from the processed signals comprises means for selecting one of the combined signal and the baseband decoded terrestrial signal to present to the user interface.

26. A computer readable medium containing executable instructions which, when executed in a processing system, cause the processing system to perform a method comprising:
receiving a satellite originated data as a satellite signal and a terrestrial repeater signal;
processing at least two channel decoding functions on the satellite signal and the terrestrial repeater signal to decode and combine the satellite signal and the terrestrial repeater signal; and
selecting information from the processed signals for presenting to a user interface.

27. A signal receiving system comprising:
a receiver comprising
a direct conversion/zero intermediate frequency RF front-end topology including two RF tuner systems configured to filter and down-convert signal from at least one antenna, one of the two RF tuner systems configured to filter and down-convert a satellite signal and the other RF of the two RF tuner systems configured to filter and down-convert a terrestrial digital audio signal, and
a software driven baseband decoding chip configured to process at least two channel decoding functions to decode and combine streams from each of the two RF tuner system and to select information for presenting to a user interface,
wherein the receiver allows compatibility with a plurality of satellite digital audio radio services.
